(19) United States
(12) Patent Application Publication
(10) Pub. No.: US 2005/0195860 A1
(43) Pub. Date: Sep. 8, 2005

(54) Combining data streams conforming to mutually exclusive signaling protocols into a single IP telephony session

(75) Inventors: Jeffrey D. Ollis, Dresher, PA (US); David T. Horoschak, Furlong, PA (US)

Correspondence Address: Lipsitz & McAllister, LLC, 755 MAIN STREET, MONROE, CT, 06468, US

(73) Assignee: General Instrument Corporation, Horsham, PA (US)

(21) Appl. No.: 10/794,904

(22) Filed: Mar. 5, 2004

(51) Int. Cl. H04J 1/00

(52) U.S. Cl. 370/487; 370/352

(57) ABSTRACT

The present invention provides methods, systems, and apparatus that allow at least two end-point IP telephony devices to synchronize multiple data streams conforming to mutually-exclusive signaling protocols into a single video telephony connection. An audio-only data stream conforming to an audio-only signaling protocol (such as PacketCable NCS) is combined with at least one video data stream conforming to one or more video signaling protocols (such as SIP or H.323) to produce a single IP telephony connection. Methods, systems, and apparatus are provided to establish an audio portion, a video portion, and optional data stream portions of a single IP telephony session.

### FIELD OF THE INVENTION

The present invention relates to the communications field. More particularly, the present invention is directed to methods, apparatus, and systems which allow an end-point device, e.g., a video telephony device, to resolve the simultaneous utilization of multiple mutually exclusive signaling protocols into a single Internet protocol (IP) telephony connection.

### BACKGROUND OF THE INVENTION

High-speed data-over-cable networks have high bandwidth capacity and deliver a mixture of analog and digital television and toll-quality telephony. Programming provided by cable service companies flows downstream to users over a cable operator's network (“the cable network”). The cable network includes a headend (the transmission source), a distribution network, and a set-top box located at the point of service. Information is carried within the distribution network using coaxial cable, fiber-optic cable, Ethernet cable (currently “Category 5” cable), microwave communication, satellite communication, and/or wireless RF communication.

A two-way cable system, allowing information to flow both downstream and upstream, can be implemented using, e.g., cable modems. An Internet service provider (ISP) gateway connects the cable network to the Internet, allowing two way communications with users that are not part of the cable network. Information flowing to and from the ISP gateway must be packetized and conform to standard Internet protocols.

Internet protocol (IP) telephony allows individuals in different locations to communicate with each other over an IP network, just as users have traditionally communicated over voice telephones using Public Switched Telephone Networks (PSTN). Additionally, IP telephony may include a combination of video, still image, and data information during a communication session. Voice telephony involves the recordation, transmission, reception, and issuance of sound. Video telephony entails the communication of both dynamic visual information and audio information and may include additional data streams for still images, slides, documents, and computer files.

Early video telephony systems—also referred to as videoconferencing systems—were expensive and required large amounts of communication bandwidth. Introduction of new audio and video compression techniques and the advent of high-speed communications networks, such as the Internet, have allowed video telephony to become more economical and popular.

Video conferencing systems have been primarily room-based, where participants go to a specially equipped conference room. In more advanced video telephony applications, it is desired to provide individual stations where participants can engage in calls at their desk, in their home, or at any other private or public location. With the proliferation of advanced wireless networks, wireless video telephony is beginning to emerge as a viable option.

A traditional video telephony system consists of video terminals for initiating, transmitting, receiving, and displaying a communication session and a network for connecting the video terminals, as illustrated in FIG. 1. The network acts as a conduit for audio/video (A/V) signals and additional data streams and may be a cable service network, a local area network (LAN), a wide area network (WAN), a wireless network, the Internet, or other method of transmitting and receiving electrical, optical, or electromagnetic signals. Additionally, a network may be formed from a combination of these disparate means of signal communication. If more than two users are simultaneously involved in a video telephony session, an optional multipoint control unit/multicast router (MCU/MR) may be used to coordinate and direct the flow of information.

A typical video terminal consists of an audio input device (microphone) and a video input device (camera) for capturing the image and sound of a user and his surroundings. An optional data input device (such as a hard drive containing computer files or a digital scanner for still pictures and documents) is used to acquire non-A/V information.

An encoder is used to convert analog information, such as audio and analog video, into digital information for transmission over the network. Once the digital information is received by another video terminal, a decoder is used to convert the digital information back into analog representations. These analog representations are then displayed to a party using speakers (audio) and monitors (video). A device which both encodes and decodes signals is referred to as a codec. For most signaling protocols, codec devices are defined by protocol standards.

Because A/V signals occur in real-time, it is important that the network provide a low and predictable delay connection, referred to as Quality of Service (QoS). There are two basic types of networks for transmitting video telephony information: (1) circuit-switched networks and (2) packet-switched networks. Circuit-switched networks, such as integrated services digital network (ISDN) and general switched telephone networks (GSTN), allocate a dedicated amount of bandwidth and a predictable delay connection.

Packet-switched networks, such as local area networks (LAN) and the Internet, break input data streams into uniform data packets and append addressing information, sequence counts, and error controls. Each packet is transmitted independently through a shared non-dedicated bandwidth network. At the receiving end, the packets are checked for errors, re-sequenced as necessary, and combined into an output data stream.

Several different types of signaling protocols are used to establish connections (e.g., point-to-point conversations) between packet-switched point-to-point devices. The most common signaling protocols are the Session Initiation Protocol (SIP), the H.323 protocol, and PacketCable network-based call signaling (NCS). However, these protocols are mutually exclusive, as they were designed independently of each other. As currently utilized, these protocols are not interoperable. Other such protocols will be apparent to those skilled in the art.

Each information stream (audio/video/data) of a video telephony session requires a negotiated codec. Video telephony requires the use of at least two codecs: one to handle the audio information stream and one to handle the video information stream. Some signaling protocols, such as SIP and H.323, allow for the negotiation of multiple codecs during a communication session. However, PacketCable NCS only supports one codec (audio) and, therefore, cannot be used to establish a video telephony connection. Accordingly, PacketCable NCS, in its present form, is not a viable protocol for video telephony.

Notwithstanding this issue, several cable service companies are striving to provide customers with telephone service based on the PacketCable NCS signaling protocol. Eventually, these cable companies may wish to provide video telephony, requiring the use of another, mutually exclusive, signaling protocol.

It would be advantageous to provide methods and systems for combining these mutually exclusive signaling protocols into a single IP telephony connection. It would also be advantageous if the receiving end-point device was able to resolve conflicts between the mutually exclusive signaling protocols without user intervention and without creating extensions to the signaling protocols. This would allow a cable service company to offer video telephony to its customers as an extension of its PacketCable NCS telephone service rather than as a completely different service.

The methods, apparatus, and systems of the present invention provide the foregoing and other advantages.

### SUMMARY OF THE INVENTION

The present invention provides methods, systems, and apparatus that allow at least two end-point IP telephony devices to combine multiple data streams conforming to mutually-exclusive signaling protocols into a single video telephony connection. An audio-only data stream conforming to an audio-only signaling protocol (such as PacketCable NCS) is combined with at least one video data stream conforming to one or more video signaling protocols (such as SIP or H.323) to produce a single IP telephony connection.

Methods, systems, and apparatus are provided to establish an audio portion, a video portion, and optional data stream portions of a single IP telephony session. In a point-to-point communication session an audio codec is negotiated between the originating end-point and the terminal end-point according to a voice signaling protocol. A voice-only call management server (CMS or “call agent”) is used to establish the audio portion of the session. According to a video signaling protocol, the end-points negotiate a video codec and a video call agent establishes the video portion of the session. The establishment of the video portion may occur simultaneously or subsequent to the establishment of the audio portion. The end-points are responsible for resolving conflicts between the voice and video signaling protocols.

### BRIEF DESCRIPTION OF THE DRAWINGS

The present invention will hereinafter be described in conjunction with the appended drawing figures, wherein like numerals denote like elements, and:

FIG. 1 is an abstract illustration of a traditional video telephony system;

FIG. 2 shows a block diagram overview of the utilization of multiple IP telephony connections to create a single IP telephony session in accordance with the invention;

FIG. 3 shows a block diagram overview of a system for combining multiple data streams conforming to mutually exclusive signaling protocols into a single IP telephony session in accordance with the invention;

FIG. 4 is a block diagram illustrating the elements of the cable network introduced in FIG. 3 in accordance with a preferred embodiment of the invention;

FIG. 5 shows a block diagram of a managed IP network in accordance with the invention;

FIG. 6 is a block diagram illustrating the elements of the managed IP network introduced in FIG. 4 in accordance with a preferred embodiment of the invention;

FIG. 7 shows a block diagram of the major elements of the media terminal adapter introduced in FIG. 3 in accordance with invention;

FIG. 8 is a table illustrating the media terminal protocol stack in accordance with the invention;

FIG. 9 is a block diagram of the elements of the media terminal adapter in accordance with a preferred embodiment of the invention.

### DETAILED DESCRIPTION OF THE INVENTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention. It should be understood that various changes may be made in the function and arrangement of elements without departing from the spirit and scope of the invention as set forth in the appended claims.

The protocols used to implement the present invention may include, but are not limited to, PacketCable Network-based Call Signaling (NCS), Packet Cable Duos, Session Initiation Protocol (SIP), Session Description Protocol (SDP), SGCP, MGCP, H.323, and the like.

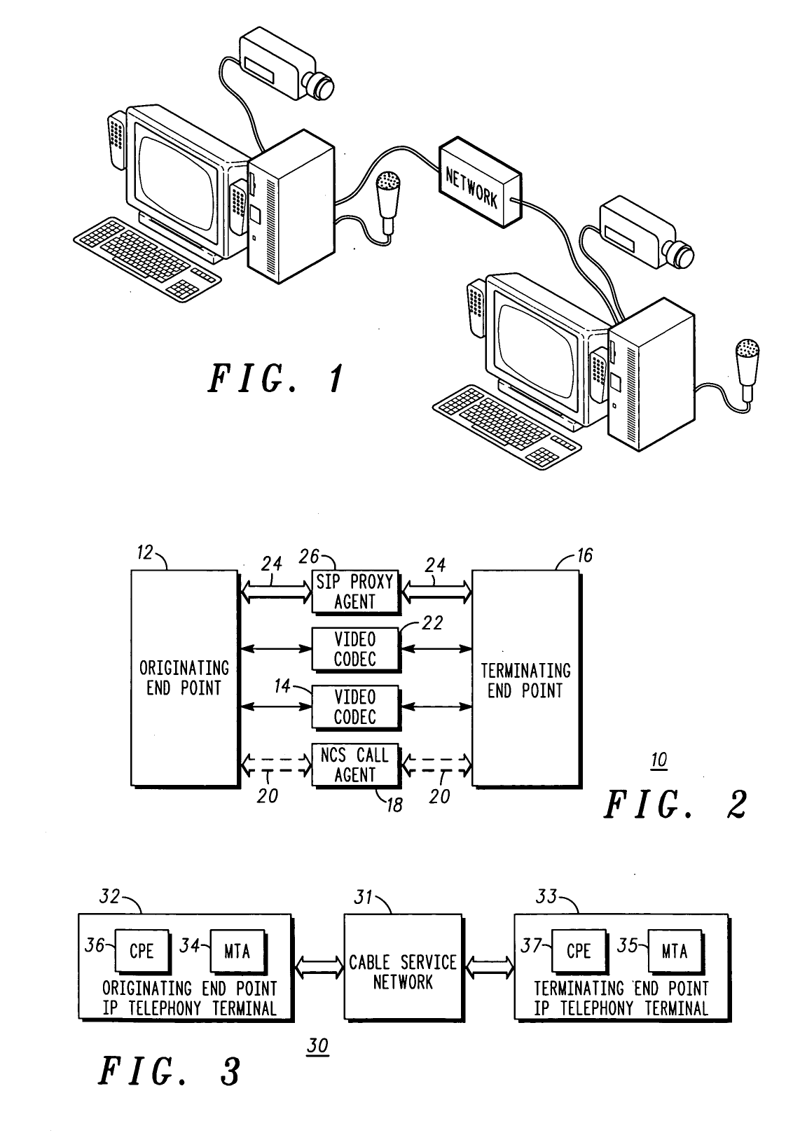

FIG. 2 is a block diagram illustrating an overview of the creation and management of an Internet protocol telephony session 10, according to the invention. An originating end-point 12 negotiates an audio codec 14 with a terminating end-point 16 according to a voice-only signaling protocol. A voice-only call agent 18, such as a PacketCable NCS call agent, is used to establish the audio portion 20 of the session 10. A video codec 22 is negotiated according to a video signaling protocol and the video portion 24 of the session 10 is established by a video call agent 26. The establishment of the video portion 24 may occur simultaneous with or subsequent to the establishment of the audio portion 20. Because the voice-only signaling protocol is mutually exclusive to the video signaling protocol, these protocols must be synchronized to form a single, continuous communication session.

In an example embodiment of the invention, as shown by the block diagram of FIG. 3, a combined protocol IP telephony system 30 includes at least two video terminals 32, 33 connected by a cable network 31. According to the invention, the cable network 31 allows for the transmission and reception of packetized information, according to Internet protocols. Each video terminal 32, 33 contains a media terminal adapter (MTA) 34 and other customer premises equipment (CPE) 36. Customer premises equipment includes the devices necessary for the capture and display of audio and video information such as microphones, video cameras, still-image scanners, hard-disk drives, speakers, and video displays. The MTA and CPE can be implemented, for example, on a personal computer (PC) running communication/signaling software.

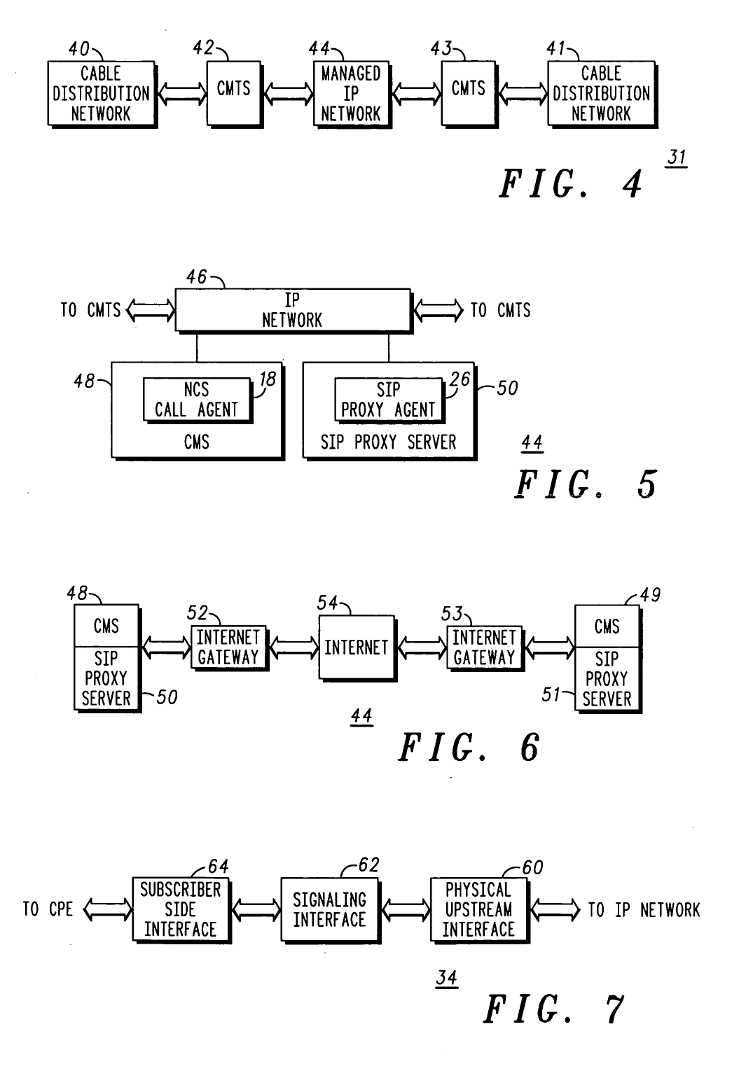

An exemplary cable network 31 is illustrated by the block diagram of FIG. 4. A cable distribution network 40, such as a coaxial cable or fiber optic network, connects the video terminal 32 (FIG. 3) to a cable modem termination system (CMTS) 42. The CMTS is an interface between the MTA 34 (FIG. 3) and the managed IP network 44. The CMTS actively terminates messages received from the MTA and provides routing, bridging, or switching functions for packetized information. A second CMTS 43 interfaces the managed IP network 44 to the second video terminal 33 (FIG. 3) through another distribution network 41.

As shown in the example implementation of FIG. 5, the managed IP network 44 includes an Internet protocol network 46 and interconnected servers 48, 50 that provide call signaling support. The IP network 46 can be any network that supports the transmission and reception of packetized information according to Internet protocols, such as a wide area network (WAN), a local area network (LAN), a wireless network, or the Internet. The call management server (CMS) 48 contains, for example, a PacketCable network-based call signaling (NCS) agent 18 for managing data streams containing audio information. The session initiation protocol (SIP) server 50 contains an SIP proxy agent 26 for managing video and other digital information data streams between the two terminals 32, 33 (FIG. 3). It should be appreciated that protocols other than SIP can alternatively be used. For example, H.323 can be used instead of SIP. Moreover, different protocols can be used for audio and video, such as H.323 for audio and SIP for video, or vice-versa.

In a preferred embodiment of a managed IP network 44, as illustrated by the block diagram of FIG. 6, a CMS server 48 and a SIP proxy server 50 are connected to the Internet 54 through an Internet gateway 52. A second Internet gateway 53 connects the Internet 54 to a second CMS server 49 and a second SIP proxy server 51.

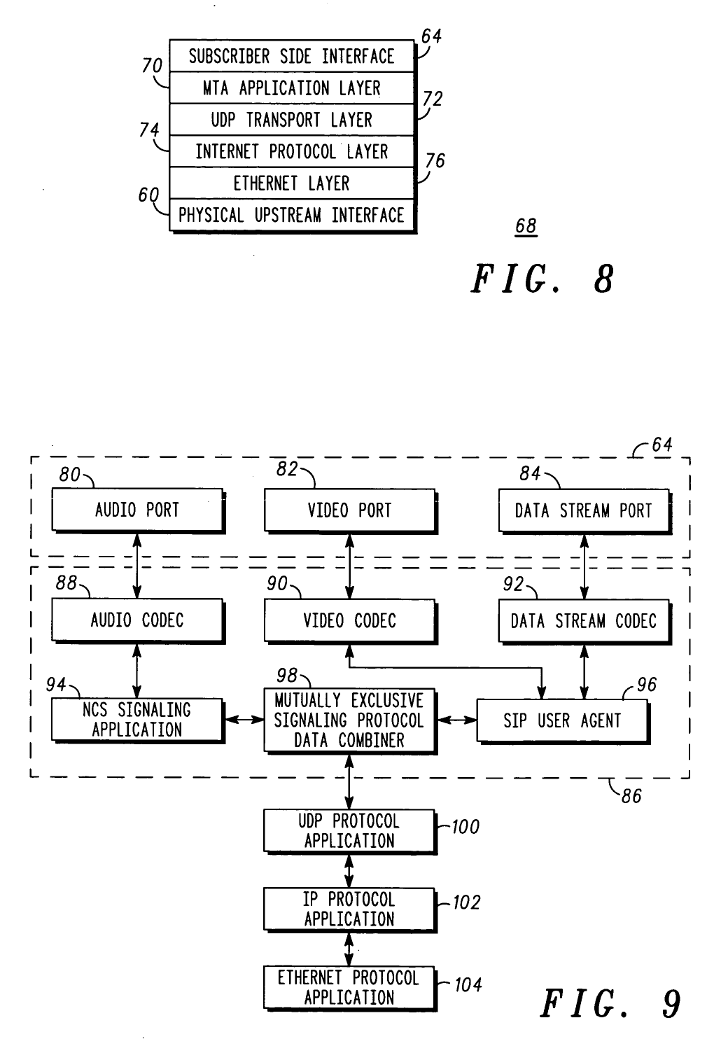

The elements of the MTA 34 (FIG. 3) are shown by the block diagram of FIG. 7. A subscriber-side interface 64 connects the customer provided equipment 36 (FIG. 3) to a signaling interface 62. A physical upstream interface 60 connects the signaling interface 62 to the cable network 31 (FIG. 3). The subscriber-side interface 64 may include a phone jack for connecting to a plain-old-telephone system (POTS), a video adapter for connecting to a video display, an audio card for connecting to a microphone and speakers, a video capture device for connecting to a camera, and/or other connectors and adapters, as needed, for other customer provided equipment. The physical upstream interface 60 may be a network interface card (NIC) or other network interface device. In a preferred embodiment of the invention, the physical upstream interface is a cable modem designed to work in conjunction with the CMTS 42 (FIG. 4) of the cable network.

An MTA protocol stack 68, roughly corresponding to the open system interconnection (OSI) protocol standard, is illustrated in FIG. 8. The MTA application layer 70 (corresponding to the application, presentation, and session layers of the OSI protocol) sits above the user datagram protocol (UDP) layer 72 (transport layer) which, in turn, rests upon the Internet protocol layer 74 (network layer). The Ethernet layer 76 (data link layer) is subordinate to the IP layer 74 and communicates through the physical upstream interface 60 (physical layer). The physical subscriber-side interface 64 has been added to connect the MTA 34 to the customer provided equipment 36 (FIG. 3).

UDP is a connectionless protocol that provides an unreliable communication channel. Messages, in the form of datagrams, are not guaranteed to arrive at their destination or to arrive in the same order they were sent. A function of the managed IP network 44 (FIG. 4) is to ensure that all UDP messages are delivered and in the correct sequence.

Those skilled in the art will appreciate that implementation of the present invention is independent of the type of transport protocol used. Depending on the specific implementation of the combined protocol telephony system 30 (FIG. 3), either UDP or transmission control protocol (TCP) may be used. Because TCP is a connection-oriented protocol, the responsibilities of the managed IP network 44 may be reduced.

The block diagram of FIG. 9 illustrates the functional units of the MTA 34 (FIG. 3). The subscriber-side interface 64 includes an audio port 80 and a video port 82. Additional data ports 84 may be used to connect optional customer premises equipment 36 (FIG. 3). The MTA application 86 is a software construct containing an audio codec 88, a video codec 90, optional data stream codecs 92, an NCS call signaling application 94, and an SIP user agent application 96. While the preferred embodiment of the invention supports allowing the software codecs to be negotiated between the video terminals 32, 33 (FIG. 3), it is recognized that other embodiments of the invention may implement the codecs as hardware devices. The NCS call signaling application 94 communicates with the NCS call agent 18 residing in the CMS server 48 of the managed IP network 44 (FIG. 6). The SIP user agent application communicates with the SIP proxy agent 26 residing in the SIP proxy server 50 of the managed IP network 44.

The UDP protocol application 100, the IP protocol application 102, and the Ethernet protocol application 104 are also software constructs. It is a common practice in the industry to store software applications such as the MTA application 86 and these protocol applications on one or more memory devices from which they can be retrieved and loaded into a computer processing device. For example, these applications may be stored on a hard-disk drive (HDD), moved into random access memory (RAM) and run on a micro-processor or central processing unit (CPU).

Audio, video, and optional information captured by the customer premises equipment 36 is passed through the ports 80, 82, 84, and coded by the codecs 88, 90, 92, respectively. Audio information is routed to the NCS call signaling application 94, while video and optional data are processed by the SIP user agent application 96. This dual data path is necessitated by the fact that PacketCable NCS signaling protocols support only one codec, and this single codec is customarily used for audio information.

Some signaling protocols, such as SIP or H.323, are capable of supporting multiple codecs, including one or more audio and video codecs and additional codecs for optional information streams. On the other hand, PacketCable NCS signaling protocols, as currently implemented in the industry, are not interoperable with these other signaling protocols and, therefore, are mutually exclusive. The incompatibility of PacketCable NCS and the flexibility of these other signaling protocols would appear to obviate the need for using PacketCable NCS call signaling for IP telephony.

However, cable service companies have a substantial infrastructure dedicated to delivering cable television service and audio only telephony utilizing PacketCable NCS. Accordingly, cable service providers are interested in supplementing, not replacing, these services. To meet these needs, it is an important aspect of the invention that the MTA 34 includes a mutually-exclusive signaling protocol data combiner (MSPDC) 98. This MSPDC is a software application or hardware device for combining (e.g., synchronizing) multiple data streams conforming to mutually exclusive signaling protocols into a single IP telephony session.

Corresponding methods are also provided in accordance with the invention.

It is noted that the above description of the invention should in no way be interpreted as limiting the scope of the present invention as other alternative embodiments are contemplated. For example, different protocols can be used for audio and video, as noted above. Further, the invention can be implemented to allow two different audio-only systems to be used, e.g., for three-way calling.

It should now be appreciated that the present invention provides advantageous methods, systems, and apparatus for combining multiple data streams conforming to mutually exclusive signaling protocols into a single IP telephony session.

Although the invention has been described in connection with various illustrated example embodiments, numerous modifications and adaptations may be made thereto without departing from the spirit and scope of the invention as set forth in the claims.

1. A method for combining data streams conforming to mutually-exclusive signaling protocols, comprising the steps of:
establishing an audio-only telephony connection between a first Internet protocol (IP) telephony terminal and a second IP telephony terminal;
establishing a non-audio information data stream connection between said first IP telephony terminal and said second IP telephony terminal; and
combining said audio-only telephony connection with said non-audio information data stream connection to form a single IP telephony session.

2. A method in accordance with claim 1, wherein:
said non-audio information data stream connection includes a video telephony connection.

3. A method in accordance with claim 1, wherein:
said non-audio information data stream connection includes a non-video information data stream connection.

4. A method in accordance with claim 1, wherein:
said non-audio information data stream connection includes a video telephony connection and a non-video information data stream connection.

5. A method in accordance with claim 1, wherein:
said audio-only telephony connection conforms to a network-based call signaling protocol (“NCS call signaling protocol”).

6. A method in accordance with claim 5, wherein:
said non-audio information data stream connection conforms to a non-NCS call signaling protocol.

7. A method in accordance with claim 6, wherein:
said NCS call signaling protocol and said non-NCS call signaling protocol are mutually exclusive.

8. A method in accordance with claim 7, wherein:
said NCS call signaling protocol is PacketCable NCS.

9. A method in accordance with claim 8, wherein:
said non-NCS call signaling protocol is session initiation protocol (SIP).

10. A method in accordance with claim 8, wherein:
said non-NCS call signaling protocol is H.323.

11. A method in accordance with claim 4, wherein:
said audio-only telephony connection conforms to a network-based call signaling protocol (“NCS call signaling protocol”).

12. A method in accordance with claim 11, wherein:
said non-audio information data stream connection conforms to a non-NCS call signaling protocol.

13. A method in accordance with claim 12, wherein:
said NCS call signaling protocol and said non-NCS call signaling protocol are mutually exclusive.

14. A method in accordance with claim 13, wherein:
said NCS call signaling protocol is PacketCable NCS.

15. A method in accordance with claim 14, wherein:
said non-NCS call signaling protocol is session initiation protocol (SIP).

16. A method in accordance with claim 15, wherein:
said non-NCS call signaling protocol is H.323.

17. A system for combining data streams conforming to mutually-exclusive signaling protocols, comprising:
a first Internet protocol (IP) telephony terminal;
a second IP telephony terminal; and
an IP communication channel between said first IP telephony terminal and said second IP telephony terminal, wherein:
said first IP telephony terminal establishes an audio-only telephony connection with said second IP telephony terminal over said IP communication channel;
said first IP telephony terminal establishes a non-audio information data stream connection with said second IP telephony terminal over said IP communication channel; and
said audio-only telephony connection and said non-audio information data stream connection are combined to form a single IP telephony session.

18. A system in accordance with claim 17, wherein:
said non-audio information data stream connection includes a video telephony connection.

19. A system in accordance with claim 17, wherein:
said non-audio information data stream connection includes a non-video information data stream connection.

20. A system in accordance with claim 17, wherein:
said non-audio information data stream connection includes a video telephony connection and a non-video information data stream connection.

21. A system in accordance with claim 17, wherein:
said audio-only telephony connection conforms to a network-based call signaling protocol (“NCS call signaling protocol”).

22. A system in accordance with claim 21, wherein:
said non-audio information data stream connection conforms to a non-NCS call signaling protocol.

23. A system in accordance with claim 22, wherein:
said NCS call signaling protocol and said non-NCS call signaling protocol are mutually exclusive.

24. A system in accordance with claim 23, wherein:
said NCS call signaling protocol is PacketCable NCS.

25. A system in accordance with claim 24, wherein:
said non-NCS call signaling protocol is session initiation protocol (SIP).

26. A system in accordance with claim 24, wherein:
said non-NCS call signaling protocol is H.323.

27. A system in accordance with claim 20, wherein:
said audio-only telephony connection conforms to a network-based call signaling protocol (“NCS call signaling protocol”).

28. A system in accordance with claim 27, wherein:
said non-audio information data stream connection conforms to a non-NCS call signaling protocol.

29. A system in accordance with claim 28, wherein:
said NCS call signaling protocol and said non-NCS call signaling protocol are mutually exclusive.

30. A system in accordance with claim 29, wherein:
said NCS call signaling protocol is PacketCable NCS.

31. A system in accordance with claim 30, wherein:
said non-NCS call signaling protocol is session initiation protocol (SIP).

32. A system in accordance with claim 30, wherein:
said non-NCS call signaling protocol is H.323.

33. An IP telephony system in accordance with claim 17, wherein:
said first IP telephony terminal includes originating end-point customer premises equipment (CPE), including an originating end-point media terminal adapter (MTA); and
said second IP telephony terminal includes terminating end-point CPE, including a terminating end-point MTA.

34. An IP telephony system in accordance with claim 33, wherein:
said originating end-point CPE includes a first audio capture device.

35. An IP telephony system in accordance with claim 34, wherein:
said terminating end-point CPE includes a first audio reproduction device.

36. An IP telephony system in accordance with claim 35, wherein:
first audio information is captured by said first audio capture device;
said first captured audio information is packetized by said originating end-point MTA and transmitted to said terminating end-point MTA over said IP communication channel;
said first transmitted packetized audio information is received by said terminating end-point MTA;
said first received packetized audio information is unpacked by said terminating end-point MTA; and
said first unpacked audio information is reproduced by said first audio broadcast device.

37. An IP telephony system in accordance with claim 36, wherein:
said terminating end-point CPE includes a second audio capture device;
said originating end-point CPE includes a second audio reproduction device;
secondary audio information is captured by said second audio capture device;
said secondary captured audio information is packetized by said terminating end-point MTA and transmitted to said originating end-point MTA over said IP communication channel;
said secondary transmitted packetized audio information is received by said originating end-point MTA;
said secondary received packetized audio information is unpacked by said originating end-point MTA; and
said secondary unpacked audio information is reproduced by said second audio broadcast device.

38. An IP telephony system in accordance with claim 37, wherein:
said originating end-point CPE includes a first video capture device;
said terminating end-point CPE includes a first video reproduction device;
first video information is captured by said first video capture device;
said first captured video information is packetized by said originating end-point MTA and transmitted to said terminating end-point MTA over said IP communication channel;
said first transmitted packetized video information is received by said terminating end-point MTA;
said first received packetized video information is unpacked by said terminating end-point MTA; and
said first unpacked video information is reproduced by said first video reproduction device.

39. An IP telephony system in accordance with claim 38, wherein:
said terminating end-point CPE includes a second video capture device;
said originating end-point CPE includes a second video reproduction device;
secondary video information is captured by said second video capture device;
said secondary captured video information is packetized by said terminating end-point MTA and transmitted to said originating end-point MTA over said IP communication channel;
said secondary transmitted packetized video information is received by said originating end-point MTA;
said secondary received packetized video information is unpacked by said originating end-point MTA; and
said secondary unpacked video information is reproduced by said second video reproduction device.
